(19) United States
(12) Patent Application Publication
(10) Pub. No.: US 2015/0321370 A1
(43) Pub. Date: Nov. 12, 2015

(54) DEVICE FOR RETAINING MULTILAYER SYNTHETIC MATERIALS ON CUTTING TABLES AND THE LIKE

(71) Applicant: COMELZ S.p.A., Vigevano (IT)

(72) Inventor: Alessandro CORSICO PICCOLINO, Vigevano (IT)

(73) Assignee: COMELZ S.P.A., Vigevano (IT)

(21) Appl. No.: 14/763,038

(22) PCT Filed: Oct. 31, 2013
(86) PCT No.: PCT/EP2013/072764

§ 371 Date: Jul. 23, 2015

(30) Foreign Application Priority Data
Jan. 25, 2013 (IT) MI2013A000113

(51) Int. Cl. B26D 7/02; B26D 7/01; B65G 21/20

(52) U.S. Cl. CPC B26D 7/025; B65G 21/209; B26D 7/018

(57) ABSTRACT

A device for retaining multilayer synthetic materials on cutting tables, comprising a supporting element adapted to be placed laterally to a multilayer to be processed, on a cutting table, and adapted to support a plate-like element whose dimensions are such as to protrude with respect to the supporting element and surmount the edge of the multilayer, the plate-like element passing from an inactive configuration to an active configuration in which the plate-like element is pressed with its edge against the edge of the multilayer.

The present invention relates to a device for retaining multilayer synthetic materials on cutting tables. More particularly, the invention relates to a device for retaining multilayer synthetic materials on cutting tables with a suction surface, for the retention of material by vacuum, and with vibrating blade cutting tools (or other cutting tools) with numeric control.

The invention further relates to a fixed suction cutting table or to a conveyor belt cutting table that implement the retention device.

As is known, in the field of cutting synthetic materials in sheet form in multiple layers on cutting tables with a suction surface, in order to retain material by vacuum, and with cutting tools provided with a vibrating blade (or other cutting tools) with numeric control, there are difficulties and limitations in achieving a retention force of the multilayer of materials on the suction surface that it is suitable to contrast the shearing forces applied to the multilayer of materials as well as the sliding friction of any presser devices arranged around the cutting tool in order to compact the material during the cutting operation.

The difficulties described above are linked closely to the capacity of the suction device of the cutting table to create a vacuum along the surfaces of the layers of material, not only on the first layer in contact with said suction surface but also on the subsequent layers that are superimposed on the first one.

Depending on the degree of permeability to air of the multilayer material, the passage of air between the layers above the one closely in contact with the suction surface, and therefore the degree of vacuum that must generate the force for retaining the multilayer, are in fact progressively limited until the desired retention effect is canceled.

Essentially, the first layer of material in contact with the cutting surface has maximum suction and the upper layers have a suction force that decreases progressively until substantially nil suction occurs proximately to the upper layer.

In other cases, in which materials that are impermeable to air are cut, suction is suppressed already from the second layer on. In other cases, materials such as fabric are cut which are highly permeable to air and in which in practice almost no vacuum is created, not even in the first layer.

The drawback observed above is solved commonly by making the vacuum penetrate between the layers through the lateral edge of the multilayer of materials, from the area of the suction surface that is directly outside the multilayer of material.

This can be done for example by means of a plastic film such as cellophane, whose dimensions exceed those of the lateral edges of the multilayer of material, thus superimposing the film on all the layers so that the vacuum generated by the suction surface outside the edge of the multilayer seals the plastic film in contact with the multilayer.

As an alternative, it is possible to use a strip of plastic film (or for example adhesive tape) just straddling the edges of the multilayer, practically sealing the edge of the last layer of material with the surface of the suction surface that is directly outside the multilayer. In this manner one obtains an adhesion between the upper layer of the multilayer and the suction surface.

However, although the solutions described above are effective for retaining the multilayer, they are generally not practical, since they entail a consumption and/or cutting of sealing material and since they furthermore generally require manual intervention by an operator.

The aim of the present invention is to provide a device for retaining multilayer synthetic materials on cutting tables with a suction surface that allows overcoming the drawbacks noted above, avoiding waste of sealing material and most of all without requiring manual intervention by the operator.

Within this aim, an object of the present invention is to provide a device for retaining multilayer synthetic materials on cutting tables that can be used in each instance without replacement costs.

Another object of the present invention is to provide a device for retaining multilayer synthetic materials on cutting tables that can be used both for fixed suction cutting tables and on conveyor belt tables.

Another object of the present invention is to provide a retention device that is highly reliable, relatively simple to provide and has competitive costs.

This aim, as well as these and other objects that will become more apparent hereinafter, are achieved by a device for retaining multilayer synthetic materials on cutting tables, characterized in that it comprises a supporting element adapted to be placed laterally to a multilayer to be processed, on a cutting table, and adapted to support a plate-like element whose dimensions are such as to protrude with respect to said supporting element and surmount the edge of said multilayer, said plate-like element transitioning from an inactive configuration to an active configuration in which said plate-like element is pressed with its edge against the edge of said multilayer.

Further characteristics and advantages of the invention will become more apparent from the description of a preferred but not exclusive embodiment of the device according to the present invention, illustrated by way of non-limiting example in the accompanying drawings, wherein:

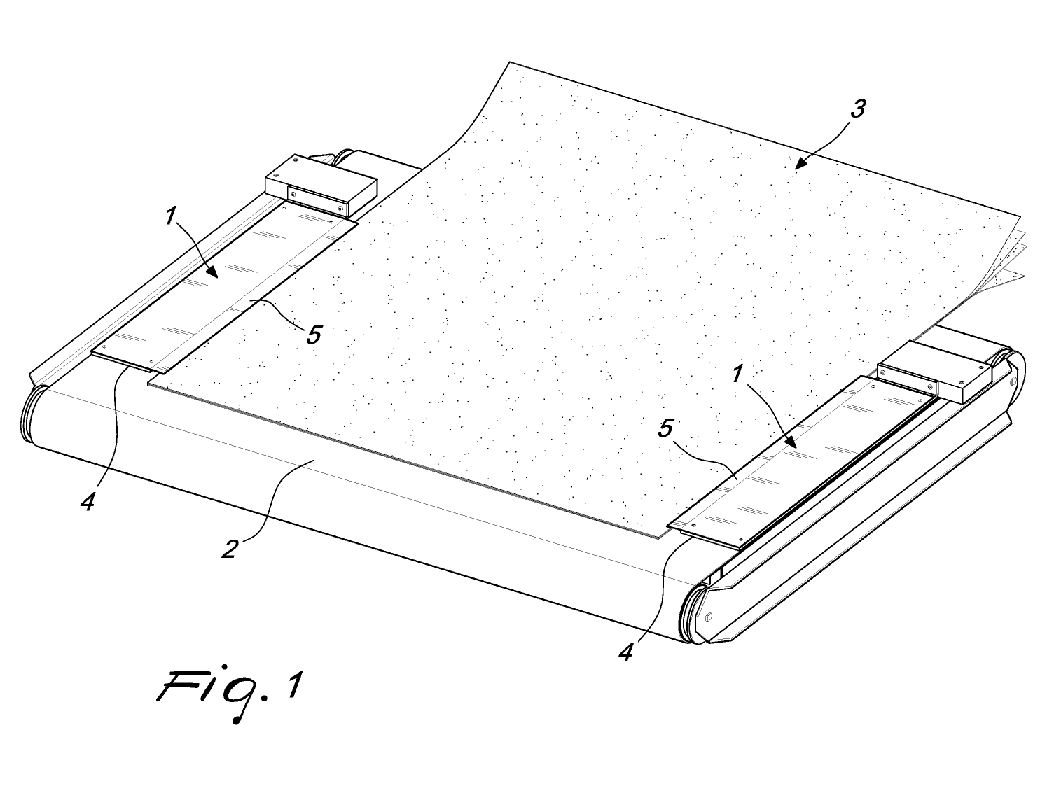

FIG. 1 is a perspective view of a suction cutting table with the device according to the invention;

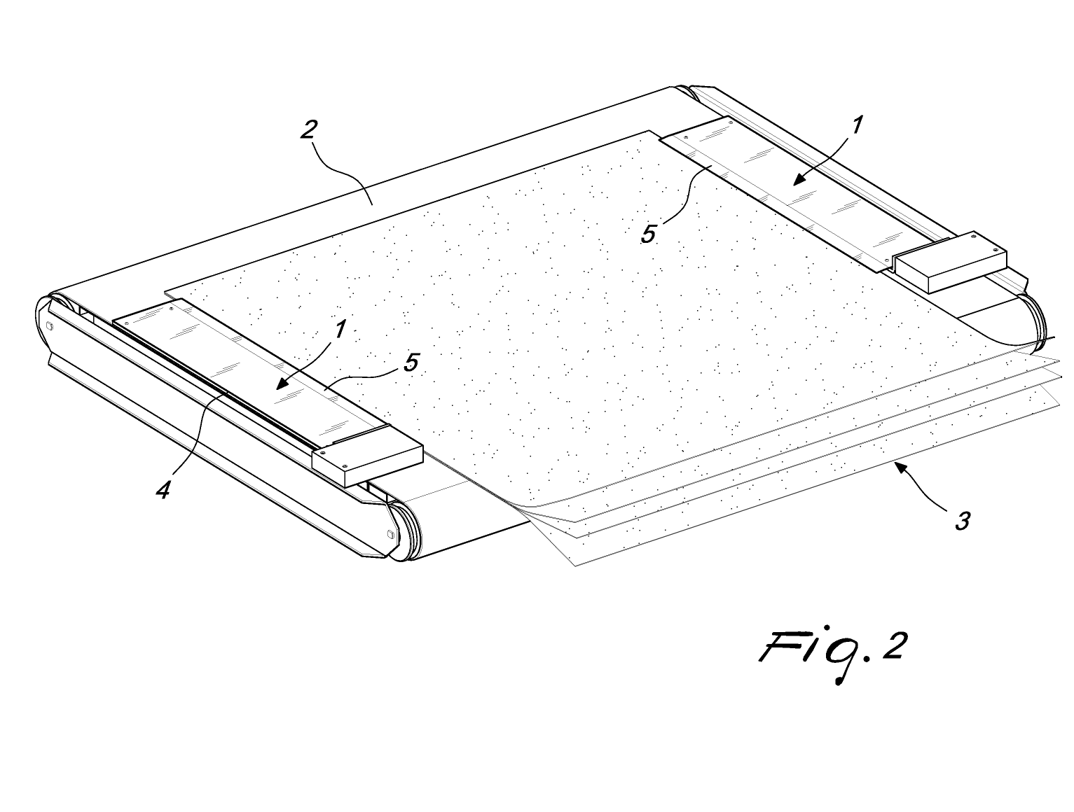

FIG. 2 is another perspective view of the cutting table with the device according to the present invention;

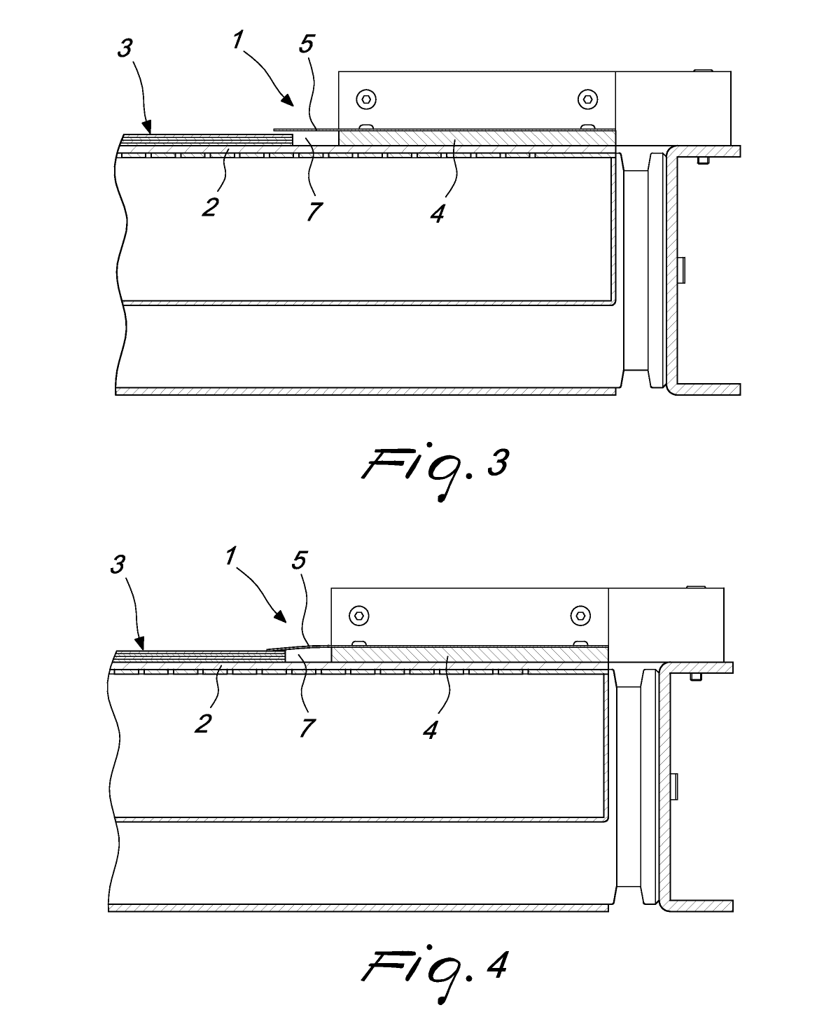

FIG. 3 is a transverse sectional view of a detail of the cutting table of FIGS. 1 and 2, showing the device according to the invention in an inactive position; and

FIG. 4 is a transverse sectional view, similar to FIG. 3, but with the device according to the invention in the active position.

With reference to the figures, the device according to the invention, generally designated by the reference numeral 1, comprises, in association with a suction cutting table 2, on which a multilayer 3 of material in sheet forms is adapted to be arranged, a supporting element 4 that is adapted to support a plate-like element 5 made of rigid but appropriately flexible material, which is arranged so as to partially surmount the edge of the multilayer 3.

A space 7 is provided between the supporting element 4 and the edge of the multilayer material 3 and forms, together with the cutting table 2 and the supporting element 4, a sort of chamber.

The plate-like element 5 extends over the length of the portion of the work area of the cutting table 2 where retention is required.

The supporting element 4 fixed to the cutting table 2 is such as to space the plate-like element 5 from the cutting table 2 by a degree that is higher than the thickness of the multilayer 3.

In this manner, under the effect of the vacuum generation means of the cutting table 2, the portion of aspirated surface that lies below the plate-like element 5 comprised between the edge of the multilayer 3 and the edge of the supporting element 4 of the plate-like element 5 forms, as mentioned above, a vacuum chamber that pushes the plate-like element 5, causing it to flex, so that it descends and thus presses on the outer edge of the multilayer 3, thus retaining it.

The vacuum that is present in this chamber draws air between the layers of material of the multilayer 3 and their lateral edges, generating on them a vacuum that is necessary for their retention, and at the same time flexes the edge of the plate-like element 5 that lies above the multilayer 3, moving its edges to press mechanically along the edge of the multilayer 3, increasing further the retention force of the multilayer 3 in contact with the cutting table 2.

The retention device according to the invention can be applied both with fixed suction cutting tables, where it can be installed on each one of the four sides of the multilayer 3, and on conveyor belt cutting tables, which are fed by continuous rolls of multilayer 3. In this case, the retention device according to the invention can be installed along each one of the two lateral edges of the multilayer 3 that is unwound from the respective rolls.

In the case of working surfaces with conveyor belts, it is necessary to bear in mind that while the retention device and in particular the supporting element must remain fixed because it operates at the cutting area, the conveyor belt and the multilayer 3 that is arranged thereon perform the movements that are necessary to arrange in the cutting area successive portions of material 3 to be cut.

Essentially, the supporting element 4 cannot be fixed permanently to the cutting table or surface 2, but must be fixed to the suction surface in order to support the plate-like element 5 when it is necessary to perform a cutting operation and therefore the multilayer 3 must be locked by the cutting surface 2, whereas it must be raised or disengaged in some way from the cutting table 2 when the conveyor belt must be moved and therefore the supporting element 4 does not have to contrast the movement of the conveyor belt.

Therefore, the supporting element 4 is supported so as to rest freely on the cutting surface 2/conveyor belt and the suction of the air of the underlying surface is controlled, activating it during the step of retention of the multilayer when the belt is stationary (therefore generating a vacuum that is capable of fixing the supporting element 4 to the cutting table or surface 2, and excluding it during the belt movement step so as to allow the sliding of the belt below the supporting element 4).

Conveniently, the plate-like element 5 can be adjustable laterally in its position for partially covering the edge of the multilayer 3, so as to be able to maintain an adequate distance from the edge of the multilayer 3 and adapt therefore to different widths of the sheets of the material being processed.

Moreover, the plate-like element 5, instead of being fixed rigidly to the supporting element 4, might be tilted externally so as to facilitate the arrangement of the multilayer 3 on the cutting table 2.

Furthermore, the supporting element 4 of the plate-like element 5 must be easily replaceable so as to adapt to different possible heights of the multilayer 3.

Essentially, therefore, the retention device according to the invention allows causing the multilayer 3 to adhere to a cutting table 2 by operating on the edge of the multilayer 3 and generating a downward force by means of the suction applied by the cutting table 2.

This suction is used advantageously also to retain the supporting element 4 in contact with the cutting table 2 if the cutting table is of the conveyor belt type and there is therefore the need to move the conveyor belt in order to position the portion of multilayer 3 to be processed in each instance at the cutting area.

Essentially, therefore, the steps of the method described above would be as follows:
actuating the conveyor belt to cause the advancement of the multilayer in the cutting area;
operating the suction in order to render the supporting element integral with the cutting table and in order to make the plate-like element adhere to the multilayer, so as to keep the multilayer “anchored” to the cutting table;
performing the cutting operation and then interrupting the suction process;
operating the conveyor belt again in order to cause the advancement of a new portion of the multilayer on the cutting table and repeating the preceding steps.

In practice it has been found that the retention device according to the present invention achieves fully the intended aim and objects, since it makes it possible to avoid the use of sealing films that require cutting of the film, a subsequent replacement thereof in each instance and a manual intervention by the operator.

The device thus conceived is susceptible of numerous modifications and variations, all of which are within the scope of the appended claims.

All the details may furthermore be replaced with other technically equivalent elements.

In practice, the materials used, as well as the contingent shapes and dimensions, may be any according to the requirements and the state of the art.

The disclosures in Italian Patent Application No. MI2013A000113 from which this application claims priority are incorporated herein by reference.

1-11. (canceled)

12. A device for retaining multilayer synthetic materials on cutting tables, comprising a supporting element adapted to be placed laterally to a multilayer to be processed, on a cutting table, and adapted to support a plate-like element whose dimensions are such as to protrude with respect to said supporting element and surmount the edge of said multilayer, said plate-like element passing from an inactive configuration to an active configuration in which said plate-like element is pressed with its edge against the edge of said multilayer.

13. The device according to claim 12, wherein said supporting element is rendered integral with said cutting table.

14. The device according to claim 12, wherein said supporting element rests on said cutting table.

15. The device according to claim 12, wherein said supporting element has such a thickness as to bring said plate-like element to a position that lies above said multilayer.

16. The device according to claim 12, wherein said plate-like element is made of a material that is rigid but has flexibility.

17. The device according to claim 12, wherein said plate-like element can be tilted with respect to said supporting element, so as to pass from an active configuration, in which said plate-like element lies above said multilayer, to an inactive configuration, in which said multilayer can be positioned freely on said cutting table.

18. The device according to claim 12, wherein said plate-like element is pressed against the edge of said multilayer by means of suction generated by said cutting table.

19. The device according to claim 12, further comprising means for the lateral adjustment of said plate-like element, which are adapted to adjust laterally said plate-like element in its position for partially covering the edge of said multilayer.

20. A cutting table of the suction type, comprising a retention device according to claim 12 for each one of the sides of the multilayer arranged on said cutting table.

21. A suction cutting table with conveyor belt, comprising a pair of retention devices according to claim 12, each retention device being arranged on one side of the multilayer adapted to be deposited on said cutting table.

22. A method for actuating a suction cutting table with conveyor belt, with a retention device according to claim 12, comprising the steps of:
actuating said conveyor belt to make a multilayer material advance in the cutting area;
actuating suction in order to render said supporting element integral with said cutting table and make said plate-like element adhere to said multilayer, in order to keep said multilayer anchored to said cutting table;
performing the cutting operation and thus interrupting suction;
actuating said conveyor belt again in order to cause the advancement of a new portion of said multilayer on said cutting table and repeating the preceding steps.
